(19) United States
(12) Patent Application Publication
(10) Pub. No.: US 2013/0306652 A1
(43) Pub. Date: Nov. 21, 2013

(54) METHOD TO IMPROVE THE BARRIER PROPERTIES OF COMPOSITE GAS CYLINDERS AND HIGH PRESSURE GAS CYLINDER HAVING ENCHANCED BARRIER PROPERTIES

(71) Applicants: Roland Andernach, Frankfurt (DE); Thomas Lindner, Gross Zimmern (DE)

(72) Inventors: Roland Andernach, Frankfurt (DE); Thomas Lindner, Gross Zimmern (DE)

(73) Assignee: Basell Polyolefine GmbH, Wesseling (DE)

(21) Appl. No.: 13/982,034

(22) PCT Filed: Jan. 18, 2012
(86) PCT No.: PCT/EP2012/000199

§ 371 Date: Jul. 26, 2013

Related U.S. Application Data
(60) Provisional application No. 61/497,414, filed on Jun. 15, 2011.

(30) Foreign Application Priority Data
Jan. 26, 2011 (EP) 11000593.1

(51) Int. Cl. F17C 1/06; B32B 37/14

(52) U.S. Cl. CPC F17C 1/06; B32B 37/14
USPC 220/590; 156/86

(57) ABSTRACT

Method to improve the barrier properties of composite gas cylinders and high pressure gas cylinder having enhanced barrier properties

The instant invention pertains to a new method for improving the barrier properties of composite gas cylinders for the storage of gas, by sheathing the outer surface of a composite gas cylinder with a tubular plastic film comprising a barrier material and shrinking it by heat treatment to approach a strong connection. The composite gas cylinder comprises an inner liner made of polyolefin and an outer fibre-reinforced, pressure supporting layer. The barrier material may comprise polyamide, polyester, halogen substituted polymer, EVOH or a metallization. The invention pertains also to a high pressure composite gas cylinder having enhanced barrier properties and its use as a fuel tank in gas driven automotive vehicles equipped with a combustion engine.

STATEMENT REGARDING FEDERALLY SPONSORED RESEARCH OR DEVELOPMENT

Not applicable.

### REFERENCE TO A COMPACT DISK APPENDIX

Not applicable.

### TECHNICAL FIELD

The present invention relates to a method improving the barrier properties of a pressure container of composite material comprising an inner liner made of polymer material, such as polyolefin or a similar material, and a fibre-reinforced, pressure supporting layer arranged outside of the inner liner.

The invention also relates to a high pressure composite gas cylinder having enhanced barrier properties against the permeation of gaseous or liquid hydrocarbons or other inflammable gases, which is useful as gas container in hospitals, as a fuel tank for gas driven automotive vehicles equipped with a combustion engine and also as propane container for gas stoves in cottages, camping caravans and small crafts or boats for recreational purposes.

### BACKGROUND OF THE INVENTION

Pressure containers for fluids have several uses, such as gas containers in hospitals and fuel containers for motor vehicles, but also in a smaller scale such as propane containers for gas stoves in cottages, camping caravans and small crafts or boats for recreational use. As a rule, such containers have been manufactured from metal. The metal, however, has the considerable disadvantage of heavy weight and difficult handling. Moreover there is often a problem of knowing how much of the original content is still left in the bottle or container.

One solution to this problem can be the pressure container's manufacture using composite material, making the container of lighter weight and more easy to handle. Because of the risk of explosion and accidents, many and strict requirements are imposed with respect to such pressure containers. Thus, the safety aspect is very essential in this connection. In particular, it is important that the container is impact resistant, so that leakages and explosions with possible following injuries to persons are reliably avoided. In addition, the barrier properties of the pressure container against the permeation of the gas comprised inside must be sufficient high.

A solution wherein the pressure container has been manufactured of composite materials is described in EP 0 810 081 A1, including a method for manufacturing pressure containers, wherein an inner, gas-impenetrable liner made of plastic first is blow moulded and thereafter an outer layer consisting of a fibre-reinforced plastic which has been soaked in a resin bath, is wound around the liner.

However, as the result of poor adhesion between the layers within these composite materials, collapse of the inner liner layer was observed due to service conditions, for example when evacuating the container, giving rise to under-pressure inside the container, or when cooling, so that the tem-perature of the fluid becomes to low. The industry considers the generally low wetting and adhesive properties of plastic material as a problem. Some of the reasons for this might be that several plastic materials have chemical inert and non-porous surfaces, having low surface tensions. The wetting and adhesive properties of plastic materials may be increased for example by flame treatment or by corona discharge treatment which are known in the art and are ready available to improve adhesion.

High pressure composite gas cylinders used especially for gas driven automotive vehicles equipped with combustion engines are commonly made of blow moulded plastic vessels reinforced with glass fibres applied in a secondary winding process. Stored gases are e.g. LPG (Liquid Pressurized Gas) or CNG (Compressed Natural Gas). The plastic material typically used for the inner liner, i.e. high molecular mass HDPE, has excellent mechanical properties with high sustainability, but it has only limited barrier properties with respect to the gases comprised. As the result of such permeability, composite gas cylinders are losing their load over some time period.

### BRIEF SUMMARY OF THE INVENTION

Thus, it was the object of the present invention to provide a method to enhance the barrier properties of composite gas cylinders for the storage of gas, especially if they are used for gas driven automotive vehicles equipped with a combustion engine as a fuel tank.

In addition, it was an object of the invention to provide a composite gas cylinder for the storage of gas having enhanced barrier properties against the permeation of gaseous or liquid hydrocarbons or other inflammable gases, which can be used as gas containers in hospitals, as a fuel tank in gas driven automotive vehicles equipped with a combustion engine and also as propane containers for gas stoves in cottages, camping caravans and small crafts or boats for recreational purposes.

It was surprisingly found that this object is achieved according to the instant invention by sheathing a composite gas cylinder, comprising an inner liner made of polyolefin and a fibre-reinforced, pressure supporting layer, with a tubular plastic film comprising a barrier material followed by subsequent shrinking by heat treatment.

The tubular polymeric film comprising the barrier material acts reliably as a stable and continuous barrier against diffusion of gaseous or liquid hydrocarbons or other inflammable gases. Dense wrapping is achieved by using cling additives.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 shows a segment of a tubular plastic film comprising the barrier material in a side view from top. The tubular plastic film shown is biaxially oriented in longitudinal and transverse direction, as symbolized by the arrows.

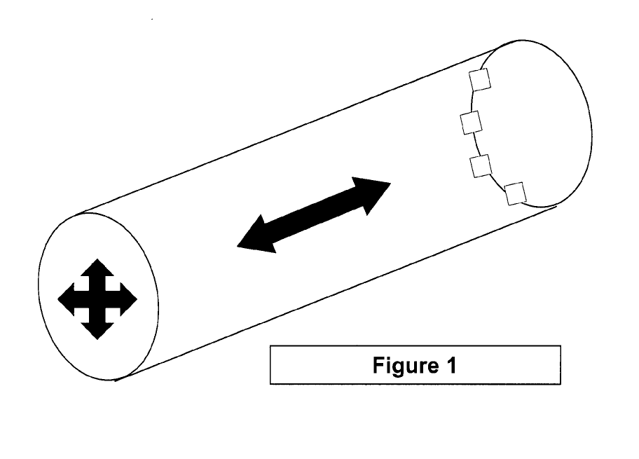

FIG. 2 shows the ready prepared inner liner in a side view.

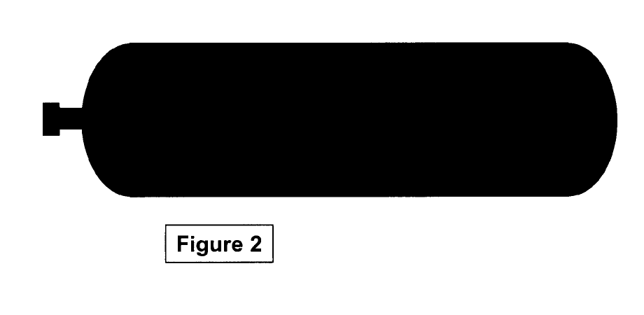

FIG. 3 shows the sheathing of the tubular plastic film comprising the barrier material by drawing it lengthwise over the outer surface of the inner liner in side view. The application of adhesives which may be used to improve a strong connection is not shown in FIG. 3.

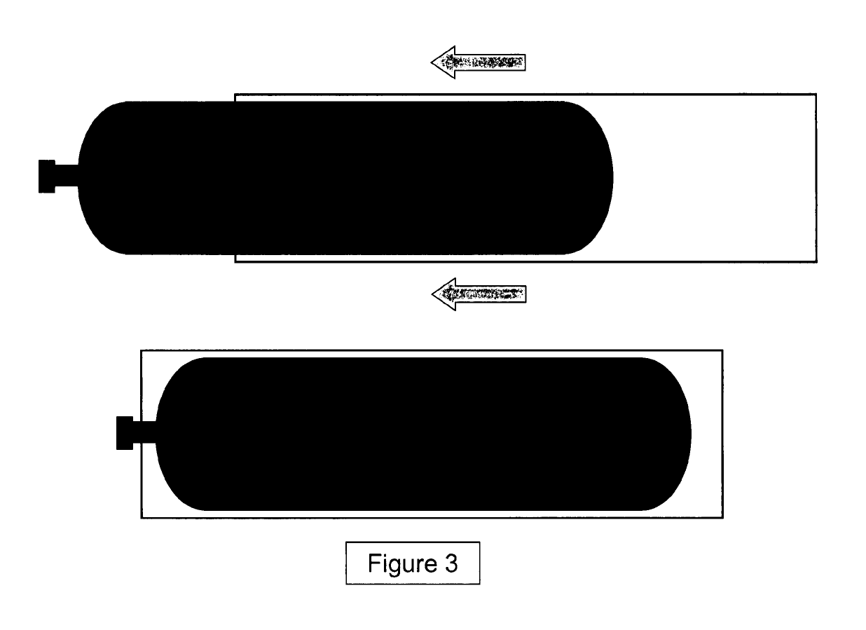

FIG. 4 shows the heat treatment of the tubular plastic film comprising the barrier material now coating the inner liner in side view. The heat treatment is applied in this example by blowing hot air on the tubular plastic film comprising the barrier material.

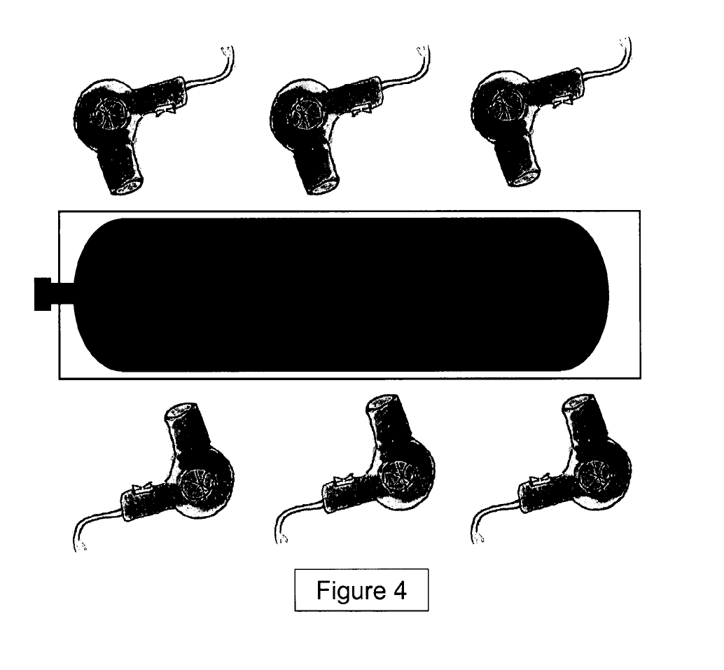

FIG. 5 shows the result of the heat treatment, whereby the tubular film covers the outer surface of the inner liner closely adhering very strong after the shrinkage caused by the heat treatment.

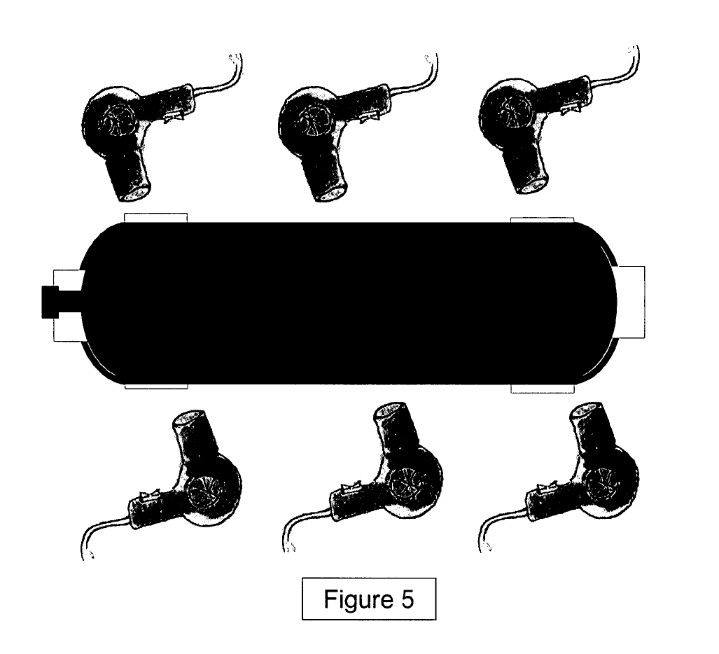

### DETAILED DESCRIPTION OF THE INVENTION

The inner liner of the composite gas cylinder is made of a thermoplastic polymer material, such as polyethylene or a copolymer of ethylene with other olefins having 3 to 10 carbon atoms or polypropylene or copolymers of propylene with ethylene or other 1-olefins having 4 to 10 carbon atoms and may be manufactured by a known process.

Examples for known processes for the manufacture of the inner liner are blow moulding, or extruding or a similar method like injection moulding.

As soon as the inner liner is ready prepared according to one of the afore-mentioned processes, then the preparation continues by either sheathing the in liner's outer surface with the tubular barrier film by drawing it lengthwise over the outer surface of the inner liner, or directly winding around the outer surface of the inner liner the fibre-reinforced, pressure supporting layer.

If the tubular plastic film comprising the barrier material is applied first, then it is in direct contact with the outer surface of the inner liner from inside and in direct contact to the fibre-reinforced pressure supporting layer from the outside. If the tubular plastic film comprising the barrier material is applied secondly, then it is only in direct contact with the fibre-reinforced, pressure supporting layer from the inside.

During the sheathing of the tubular plastic film comprising the barrier material in addition adhesives may be used to improve the strong connection which may be an epoxy-polymer or a similar means or a hot melt or another solvent free adhesive composition. If desired, the tubular barrier film may be applied in two or three ore even more layers.

As barrier material polymers are preferably used having a very low permeability for gaseous or liquid hydrocarbons. Such polymers are polyamides like polyhexamethylene adipineamide or poly-epsilon-caprolactame or polyesters like polyethyleneterephthalete or polybutylene-terephthalate or halogen substituted polymers like polyvinylchloride (PVC) or polyvinylidenechloride (PVDC) or fluorine comprising polymers such as polytetrafluorineethylene (PTFE) or ethylene vinylalcohol copolymer (EVOH). In addition, metallization of the surface of a plastic film, e.g. by vapour deposition, is also a suitable method to improve the film's barrier properties.

The barrier properties of the plastic film might be achieved by mono-layer film extrusion of plastic material with very low permeability, suitable for polyamides or polyesters or halogenic polymers, or by multi-layer co-extrusion of semi-permeable plastic materials with tie layers and barrier layers in-between used for PTFE or EVOH or by mono-layer film blowing of semi-permeable polymers and additional coating with barrier layers, such as metallization.

The tubular film may be produced by a casting process or by film extrusion through a slit die on a cooling drum and subsequent connection of the outer edges to form a tube or preferably by bubble blowing film extrusion through an annular die. The tubular film must be oriented biaxially in two perpendicular directions, such as longitudinal and transverse, to cause shrinkage during its heat treatment. The biaxial orientation may be effected either by stretching a flat film in two perpendicular directions or by drawing and blowing during the bubble blowing process using an annular die. The connection of the outer edges of a flat film to produce a tube may be effected by heat sealing or by welding or by the application of a suitable adhesive.

To cause the shrinkage and to improve the adhesion of the tubular barrier film at the outer surface of the inner liner or the composite gas cylinder, a final heat treatment is applied. Such heat treatment is performed in a furnance or by blowing hot air at a temperature of from 60 to 200 ° C., preferably from 70 to 150 ° C., more preferred from 80 to 130 ° C., depending from the chemical composition of the barrier material and the plastic film. The treatment is maintained over a time period depending from the temperature applied of about 5 seconds to 5 minutes, preferably from 10 seconds to 3 minutes.

As soon as the outer surface of the inner liner is ready coated and heat treated according to the afore-mentioned processes, then the preparation continues by winding around some fibre-reinforced elements, for example glass fibre bands or treads to support the pressure resistance. These fibre-reinforced bands or treads are preferably applied according to the filament winding process which is well known in the art.

Suitable adhesion between the plastic film comprising the barrier material and the fibre-reinforced, pressure supporting layer is typically obtained by the application of surface corona treatment in combination with adhesives. An epoxy-polymer or a similar means may be used as adhesive. The adhesive may be applied onto the plastic film comprising the barrier material covering the inner liner before winding of the fibre-reinforced, pressure supporting layer onto the plastic film. Alternatively, the adhesive can at first be applied onto the inner side of the fibre-reinforced layer before adhesion on the plastic film comprising the barrier material coating the outer side of the inner liner. The adhesive may also be employed at the same time as the fibre-reinforced, pressure supporting layer is wound onto the plastic film comprising the barrier material on the outer side of the inner liner. In addition, direct contact between the plastic film comprising the barrier material and the fibre reinforced, pressure supporting layer is possible, as well.

The pressure composite plastic gas cylinder prepared in accordance with the method of the instant invention has a very low permeability for gaseous or liquid hydrocarbons or other inflammable gases of less than 2·10-4 of the permeability of a pressure composite gas cylinder not comprising the barrier material, preferably of less than 1.5·10-4, more preferred of less than 1·10-4. The tubular plastic film comprising the barrier material may be applied as a single layer or in two or three or even more layers.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of the ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

1. A method of producing a composite gas cylinder comprising the steps of:
(i) shething a composite gas cylinder with a tubular plastic film comprising a barrier material to produce a shethed composite gas cylinder, wherein the composition gas cylinder comprises an inner liner made of polyolefin and an outer fibre-reinforced, pressure supporting layer; and
(ii) shrinking the shethed composite gas cylinder by treating the shethed composite gas cylinder with heat.

2. A method according to claim 1, wherein polymers are used as barrier material having a very low permeability for hydrocarbons comprising polyamides like polyhexamethylene adipineamide or poly-epsilon-caprolactame or polyesters like polyethyleneterephthalete or polybutyleneterephthalate or halogen substituted polymers like polyvinylchloride (PVC) or polyvinylidenechloride (PVDC) or fluorine comprising polymers such as polytetrafluorineethylene (PTFE) or polyvinylalcohol (PVA).

3. A method according to claim 1, wherein the inner liner is made of a polymer comprising polyethylene or a copolymer of ethylene with other olefins having 3 to 10 carbon atoms or polypropylene or a copolymer of propylene with ethylene or other 1-olefins having 4 to 10 carbon atoms and is manufactured using such polymers by blow moulding, or extruding or by injection moulding.

4. A method according to claim 1, wherein the fibre- reinforced, pressure supporting layer is applied by winding fibre-reinforced elements comprising glass fibre bands or treads around the outer surface of the inner liner according to the filament winding process.

5. A method according to claim 1, wherein the fibre-reinforced, pressure supporting layer is applied by winding fibre-reinforced elements comprising glass fibre bands or treads around the outer surface of the tubular plastic film comprising the barrier material coated onto the outer surface of the inner liner according to the filament winding process.

6. A method according to claim 1, wherein an epoxy-polymer or a similar adhesive or a hot melt adhesive is used to improve the adhesion between the inner liner and the fibre-reinforced, pressure supporting layer or between the inner liner and the tubular plastic film comprising the barrier material or between the tubular plastic film comprising the barrier material and the outer fibre-reinforced, pressure supporting layer.

7. A method according to claim 1, wherein a section of the tubular plastic film comprising the barrier material is sheathed onto the outer surface of the inner liner by lengthwise drawing and whereby adhesives are used to improve the adhesion which comprise an epoxy-polymer or a similar means or which comprise a hot melt adhesive or another solvent free adhesive composition.

8. A method according to claim 1, wherein a section of the tubular plastic film comprising the barrier material is sheathed onto the outer surface of the composite gas cylinder comprising the inner liner and an outer fibre-reinforced, pressure supporting layer by lengthwise drawing and whereby adhesives are used to improve its adhesion which comprise an epoxy-polymer or a similar means or which comprise a hot melt or another solvent free adhesive composition.

9. A method according to claim 1, wherein a heat treatment is applied to the tubular plastic film comprising barrier material in a furnance or by blowing hot air at a temperature of from 60 to 200° C., preferably from 70 to 150° C., more preferred from 80 to 130° C., over a time period depending from the temperature applied of about 5 seconds to 5 minutes, preferably from 10 seconds to 3 minutes.

10. A high pressure composite plastic gas cylinder prepared according to claim 1, which is sheathed at least partially with a tubular plastic film comprising a barrier material and has a permeability for gaseous or liquid hydrocarbons or other inflammable gases of less than 2×10⁻⁴of the permeability of a pressure composite gas cylinder not comprising the barrier material.

11. A high pressure composite plastic gas cylinder according to claim 10, wherein the tubular plastic film comprising barrier material is applied in two or three or more layers.

12. (canceled)
